(19) United States
(12) Patent Application Publication
(10) Pub. No.: US 2012/0159361 A1
(43) Pub. Date: Jun. 21, 2012

(54) DATA SYNCHRONZATION SYSTEM AND METHOD FOR WIDGET AND CORRESPONDING APPLICATION

(75) Inventor: TING-CHIEH LIN, Tu-Cheng (TW)

(73) Assignee: HON HAI PRECISION INDUSTRY CO., LTD., Tu-Cheng (TW)

(21) Appl. No.: 13/172,163

(22) Filed: Jun. 29, 2011

(30) Foreign Application Priority Data
Dec. 15, 2010 (TW) 99144022

(51) Int. Cl. G06F 3/048

(52) U.S. Cl. 715/765

(57) ABSTRACT

A synchronization system for a widget and a corresponding application includes a display and a processor. The processor includes a background management module, an application window module, a widget, and a widget management module. The application layer is adapted to store application data, and tell the background management module to download updated data corresponding to the application via a network, after determining a storage time of the application data is greater than a reference time. The application window module is adapted to obtain the application data or the updated data from the application layer and display the application data or the updated data. The widget is displayed. The widget management module is adapted to obtain the widget data of the application data or the updated data from the application layer and send the widget data to the widget.

### BACKGROUND

1. Technical Field

The present disclosure relates to a data synchronization system and method for a widget and a corresponding application.

2. Description of Related Art

A widget is an element of a graphical user interface (GUI) that displays information which is changeable by the user, such as a window or a text box. The defining characteristic of a widget is to provide a single interaction point for direct manipulation of a given kind of data. In other words, widgets are basic visual building blocks, which combined in an application hold all the data processed by the application and the available interactions on this data. The data for widgets and the applications corresponding to the widgets are from different databases. Users may sometimes see different data from the widgets and the corresponding applications.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of the remote control system.

FIG. 2 is a flow chart of data displaying of widget data in accordance with an embodiment.

FIG. 3 is a flow chart of data displaying of application data in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

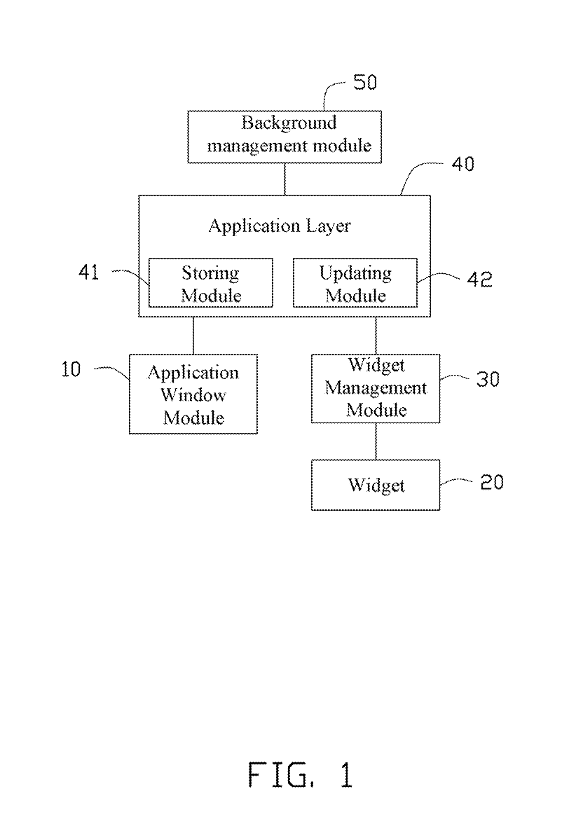

Referring to FIG. 1, a data synchronization system includes a processor and a display. The processor includes an application window module 10, a widget 20, a widget management module 30, an application layer 40, and a background management module 50. The application window module 10 and the widget 20 are used for being displayed on the display.

The application window module 10 is used for obtaining and displaying application data of an application, for example, e-mail data. The e-mail data includes e-mail number in a sending box, new e-mail number in receiving box.

The widget 20 is used for displaying widget data of an application. The widget data is a part of the application.

The widget management module 30 is used for obtaining the widget data and sending the widget data to the widget 20. In one embodiment, the widget management module 30 sends the widget data via a broadcast.

The application layer 40 includes a storing module 41 and updating module 42. The storing module 41 is used for storing the application data of the application. The updating module 42 is used for determining if a storage time of the application data is greater than a reference time. If so, the updating module 42 tells the background management module 50 to download updated data corresponding to the application. If not, the updating module 42 sends the widget data to the widget and the application data to the widget management module 30.

The background management module 50 is used for downloading the updated data and sending the updated data to the storing module 41 to store.

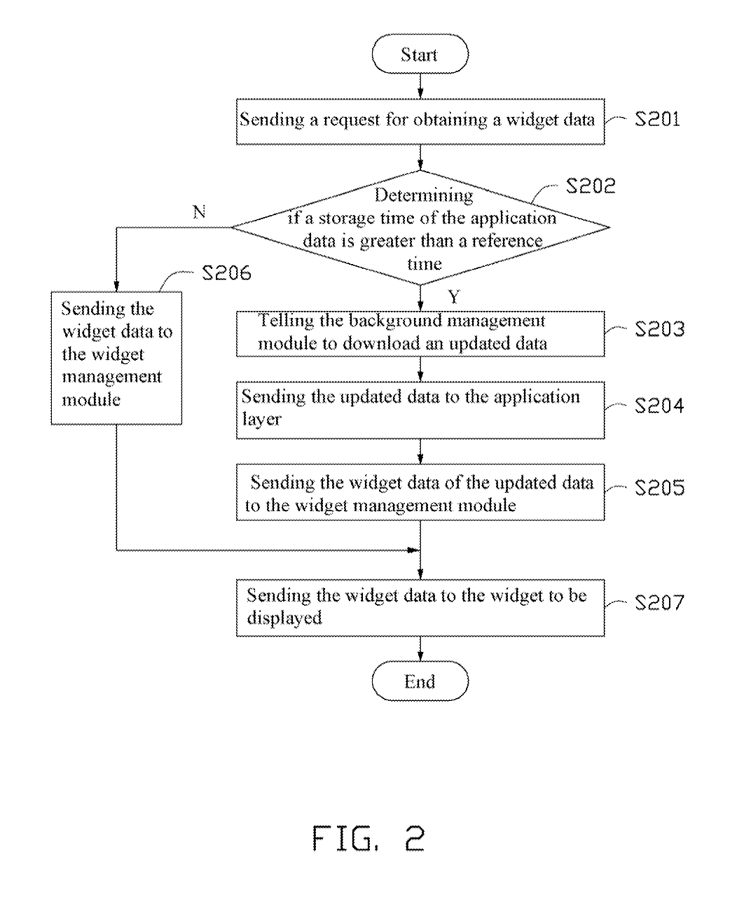

Referring to FIG. 2, a data displaying method of the widget 20 is shown. An embodiment of the method is as follows.

In step S201, the widget management module 30 sends a request for obtaining widget data to the application layer 40.

In step S202, the updating module 42 determines if a storage time of the application data stored in the storing module 41 is greater than the a reference time. If so, the process turns to the step S203. If not, the process turns to the step S206.

In step S203, the updating module 42 tells the background management module 50 to download an updated data corresponding to the application via a network.

In step S204, the background management module 50 transmits the updated data to the storing module 41 to be stored.

In step S205, the updating module 42 sends a widget data of the updated data to the widget management module 30.

In step S206, the updating module 42 conveys a widget data of the application data stored in the storing module 41 to the widget management module 30.

In step S207, the widget management module 30 communicates the widget data to the widget 20 to be displayed.

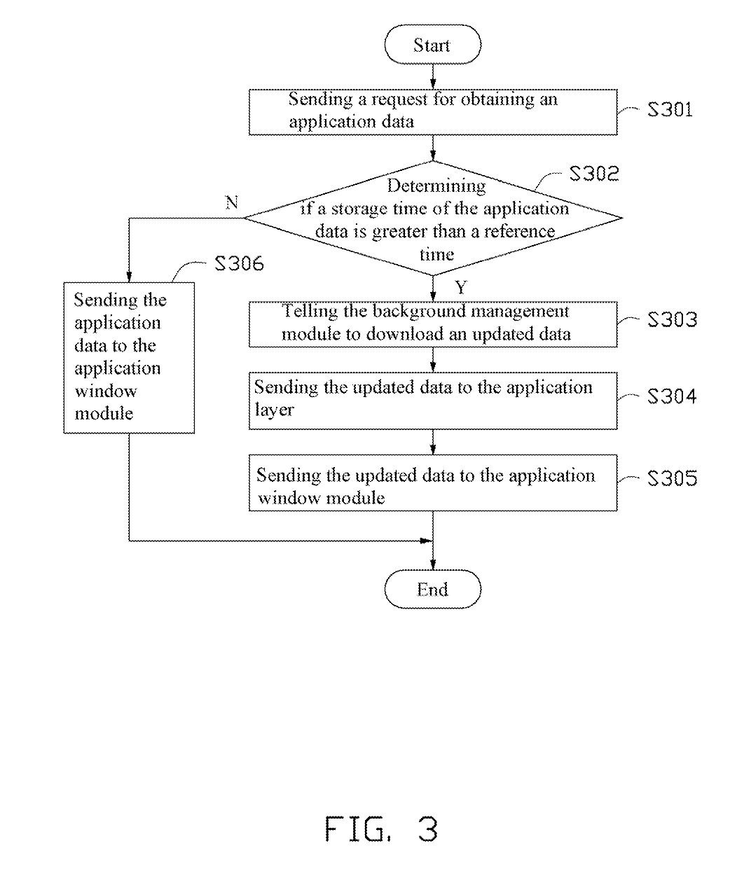

Referring to FIGS. 1 and 3, a data displaying method of the application data is shown. An embodiment of the method is as follows.

In step S301, the application window module 10 sends a request for obtaining the application data corresponding to an application.

In step S302, the updating module 42 of the application layer 40 determines if a storage time of the application stored in the storing module 41 is greater than the a reference time. If so, the process turns to the step S303. If not, the process turns to the step S306

In step S303, the updating module 42 tells the background management module 50 to download updated data corresponding to the application.

In step S304, the background management module 50 sends the updated data to the storing module 41 to be stored.

In step S305, the updating module 42 sends the updated data to the application window module 10 to be displayed.

In step S306, the updating module 42 sends the application data stored in the storing module 41 to the application window module 10 to be displayed.

The data displayed by the widget 20 and the application window module 10 comes from the application layer 40. The application layer 40 updates the application data during a time period, which enables the data to be displayed by the widget 20 and the application window module 10 to synchronize.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A synchronization system for a widget and a corresponding application, comprising:
a display; and
a processor, the processor comprising:
a background management module;
an application layer, the application layer adapted to store an application data of an application and inform the background management module to download an updated data corresponding to the application via network after determining a storage time of the application data is greater than a reference time;
an application window module, the application window module adapted to obtain the updated data from the application layer and display the updated data on the display;
a widget, the widget adapted to display a widget data of the application data or the updated data on the display; and
a widget management module, adapted to obtain the widget data of the updated data from the application layer and send the widget data to the widget.

2. The synchronization system of claim 1, wherein the application layer is adapted to determine if the storage time of the application data is greater than the reference time after receiving a request for obtaining the widget data from the widget management module or obtaining the application data from the application window module and obtaining the application data from the application window module.

3. The synchronization system of claim 1, wherein the application layer comprises a storing module and an updating module; the storing module is adapted to store the updated data; the updating module is adapted to send the updated data to the application window module and the widget after determining the storage time of the application data is less than the reference time.

4. The synchronization system of claim 1, wherein the widget management module is adapted to send the widget data to the widget via broadcast.

5. A data synchronization method, comprising:
providing an application layer, the application layer provides an application data of an application to an application window module and a widget;
downloading an updated data corresponding to the application via a background management module after determining a storage time of the application data is greater than a reference time, and
sending the updated data to the application layer.

6. The data synchronization method of claim 5, further comprising receiving a request for obtaining a widget data from a widget management module and obtaining the application data from the application window module before determining if the storage time of the application data is less than the reference time.

7. The data synchronization method of claim 5, wherein the application layer comprises a storing module and an updating module; the storing module stores the updated data; the updating module sends the updated data to the application window module and the widget after determining the storage time of the application data is less than the reference time.

8. The data synchronization method of claim 5, wherein the widget obtains a widget data of the application data via broadcast sent by a widget management module.

9. A data synchronization method, comprising:
providing a background management module, an application layer, an application window module, a widget, and a widget management module;
downloading an updated data corresponding to an application via the background management module after determining a storage time of an application data of the application is greater than a reference time, and
sending the updated data via the background management module to the application layer; and
obtaining the updated data via the application window module and obtaining a widget data of the updated data and sending the widget data to the widget via the widget management module.
